(19) United States
(12) Patent Application Publication
(10) Pub. No.: US 2020/0312036 A1
(43) Pub. Date: Oct. 1, 2020

(54) DYNAMIC DIGITAL REPLICAS OF PRODUCTION FACILITIES

(71) Applicant: BP Corporation North America Inc., Houston, TX (US)

(72) Inventors: Khoa Nguyen, Katy, TX (US); Cory Dailey, Katy, TX (US); Evan Ghazi, Houston, TX (US); Susan Zeigle, Katy, TX (US)

(73) Assignee: BP Corporation North America Inc., Houston, TX (US)

(21) Appl. No.: 16/827,762

(22) Filed: Mar. 24, 2020

Related U.S. Application Data
(60) Provisional application No. 62/827,633, filed on Apr. 1, 2019.

(51) Int. Cl. G06T 19/00; G06N 5/04; G06T 7/00; G08B 21/18

(52) U.S. Cl. CPC G06T 19/006; G06N 5/04; G06T 2207/30164; G08B 21/187; G06T 7/0004

(57) ABSTRACT

In some examples, a method comprises receiving, by a computer system, data from a plurality of equipment of a production facility; displaying, on a display unit of the computer system, a dynamic digital replica of the production facility, wherein accessing a digital replica of one of the plurality of equipment via the dynamic digital replica displays data for the one of the plurality of equipment of the production facility; analyzing the data for the one of the plurality of equipment; and generating, based on the analysis, a report on a health of the one of the plurality of equipment.

### CROSS-REFERENCE TO RELATED APPLICATIONS

This application claims benefit of U.S. provisional patent application Ser. No. 62/827,633 filed Apr. 1, 2019, and entitled “Dynamic Digital Replica of Offshore Facilities,” which is hereby incorporated herein by reference in its entirety.

### BACKGROUND

To satisfy equipment, safety, and regulatory requirements, oil and gas production companies are typically obligated to inspect and maintain production facilities and equipment used therein over the complete life cycle of the associated operations. When equipment maintenance and integrity plans are insufficient, equipment performance may suffer and the risk of injuries may increase. Increased equipment downtime often results in the loss of day rates, fines, and in some cases, may result in the loss of a license to operate. As part of an equipment or asset management strategy, owners implement equipment maintenance and integrity plans and associated tasks to improve asset availability while increasing efficiency, accuracy, and quality of the facility.

### SUMMARY

Embodiments of methods for dynamic digital replicas of production facilities are disclosed herein. In accordance with at least one example of the disclosure, a method comprises receiving, by a computer system, data from a plurality of equipment of a production facility; displaying, on a display unit of the computer system, a dynamic digital replica of the production facility, wherein accessing a digital replica of one of the plurality of equipment via the dynamic digital replica displays data for the one of the plurality of equipment of the production facility; analyzing the data for the one of the plurality of equipment; and generating, based on the analysis, a report on a health of the one of the plurality of equipment.

Embodiments of systems for dynamic digital replicas of production facilities are disclosed herein. In accordance with another example of the disclosure, a system comprises a display unit; a storage device comprising machine-readable instructions; and a processor coupled to the display unit and the storage device. Execution of the machine-readable instructions causes the processor to cause the display unit to display a dynamic digital replica of a production facility comprising a plurality of equipment; receive data on the plurality of equipment from multiple data sources; analyze the data; and based on the analysis, notify when an issue with one of the plurality of equipment is detected.

Embodiments of computer-readable mediums for dynamic digital replicas of production facilities are disclosed herein. In accordance with yet another example of the disclosure, a computer-readable medium storing executable code which, when executed by a processor, causes the processor to: display, on a display unit coupled to the processor, a dynamic digital replica of a production facility comprising a plurality of equipment. The dynamic digital replica is configured to integrate multiple data sources providing details related to the equipment; analyze the multiple data sources; and based on the analysis, notify when an issue with one of the plurality of equipment is detected.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various examples, reference will now be made to the accompanying drawings in which:

FIG. 1 depicts a computer system for displaying a screen image showing a portion of a dynamic digital replica of an offshore production facility, in accordance with embodiments described herein.

FIG. 2 depicts a graphical user interface (GUI) showing a view of the offshore production facility, in accordance with embodiments described herein.

FIG. 3 depicts a graphical user interface (GUI) showing another view of the offshore production facility, in accordance with embodiments described herein.

FIG. 4 depicts an illustrative block diagram of a computer system, in accordance with embodiments described herein.

FIG. 5 depicts an illustrative method that can be used to generate the digital dynamic replica, in accordance with embodiments described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections. Similarly, a device that is coupled between a first component or location and a second component or location may be through a direct connection or through an indirect connection via other devices and connections. An element or feature that is “configured to” perform a task or function may be configured (e.g., programmed or structurally designed) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof. Additionally, uses of the phrases “ground” or similar in the foregoing discussion are intended to include a chassis ground, an Earth ground, a floating ground, a virtual ground, a digital ground, a common ground, and/or any other form of ground connection applicable to, or suitable for, the teachings of the present disclosure. Unless otherwise stated, “about,” “approximately,” or “substantially” preceding a value means+/−10 percent of the stated value.

Some offshore production facilities are referred to as floating cities because even the smallest offshore platforms have more than a dozen people living and working aboard. Larger facilities, which may be anchored to the sea bed below, might have as many as 200 people aboard to operate the rig effectively. Maintaining production facilities that pump thousands of barrels of oil a day from a subterranean reservoir disposed below the sea floor utilizes—at all times—a variety of essential personnel performing different jobs including, without limitation, operators, maintenance technicians, welders, divers, engineers, cooks, safety personnel, and medical personnel. In addition to such personnel, additional maintenance personnel regularly travel to the facility for equipment inspections and maintenance. At least some of these regular maintenance activities are preventive in nature, and thus, are performed visually.

In addition to the regular maintenance activities, an equipment survey crew is typically sent aboard when the offshore production facility is modified, for example, by replacing an important piece of equipment, such as a pump. These multiple layers of inspection add to the overall cost, are time consuming, and create redundancies. In addition, offshore production facilities are inherently complex and can be dangerous; the constant influx and outflow of people may add to risks. Thus, it is generally desirable to reduce the number of people aboard an offshore production facility at any given time.

To improve the quality, performance, and efficiency of inspection and maintenance, the power of automation and data is used by the rig operators, engineers, maintenance and inspection crews to aid their decision making. In some cases, the offshore production facility may use the following types of maintenance-related software tools: integration and data management software, operations planning and reporting software, analytics and assurance software, real-time solutions software, equipment condition monitoring software, etc. The list of software tools mentioned herein is not exhaustive. Each of the above-mentioned software tools performs a multiplicity of different functions and generates a surfeit of distributed data relevant to its operators. The use of a large number of software tools is sometimes cost ineffective and generates distributed data, which may create redundancies and reduce the overall efficiency of the inspection or maintenance of the rigs. Thus, there is a need for systems and methods to mitigate the issues mentioned above. In particular, there is a need to aggregate all the distributed data to reduce redundancies and fully utilize the generated data. Such systems and methods may improve the quality of equipment maintenance, reduce the number of people aboard at any given time, and enhance the use of automation tools overall.

Accordingly, this disclosure describes systems and methods to aggregate all the distributed data to mitigate the issues mentioned above. The disclosure describes a visualization tool that can combine the plethora of information gathered by the multiplicity of maintenance and inspection related software tools employed in production facilities. Combining this distributed data into a single visualization tool makes the overall workflow systematic and harmonious. As described below, such a visualization tool can improve the quality of equipment inspection and maintenance and also may result in the reduction of the number of people aboard any given time.

At least in some examples, the visualization tool is a digital replica (or “twin”) of the production facility, where the digital replica provides visualization of the physical entity throughout its life cycle. Thus, the digital replica can be labeled or described as being “dynamic” in nature. In one example, the dynamic nature of the digital replica is facilitated by access to historical data about the production facility. In another example, the dynamic nature of the digital replica is facilitated by real-time data provided by sensors placed on the production facility. In yet another example, the dynamic nature assists in predicting the future health of all the equipment, which can further provide predictability from a maintenance and inspection perspective.

In addition to being a digital replica, in at least some examples, the digital replica is configured to replace the use of a multiplicity of software tools by integrating the functions of the multiplicity of software tools into the digital replica such that the digital replica acts as a single dynamic visual repository and functions as a single visual and software tool that can let operators and engineers assess the health of the offshore production facility in real-time. The digital replica can also be accessed by an onshore team of engineers and operators. This onshore-accessibility feature facilitates the equipment inspection and maintenance, and reduces of the total number of people aboard any given time.

Having a single dynamic visual repository allows the operators and engineers to quickly, easily, and naturally perform four-dimensional data analysis by enabling the transformation of information from multitudes of software systems into a visual knowledge base, which supports decision-making for the many processes that are involved in maintaining and running a complex system like the offshore production facility.

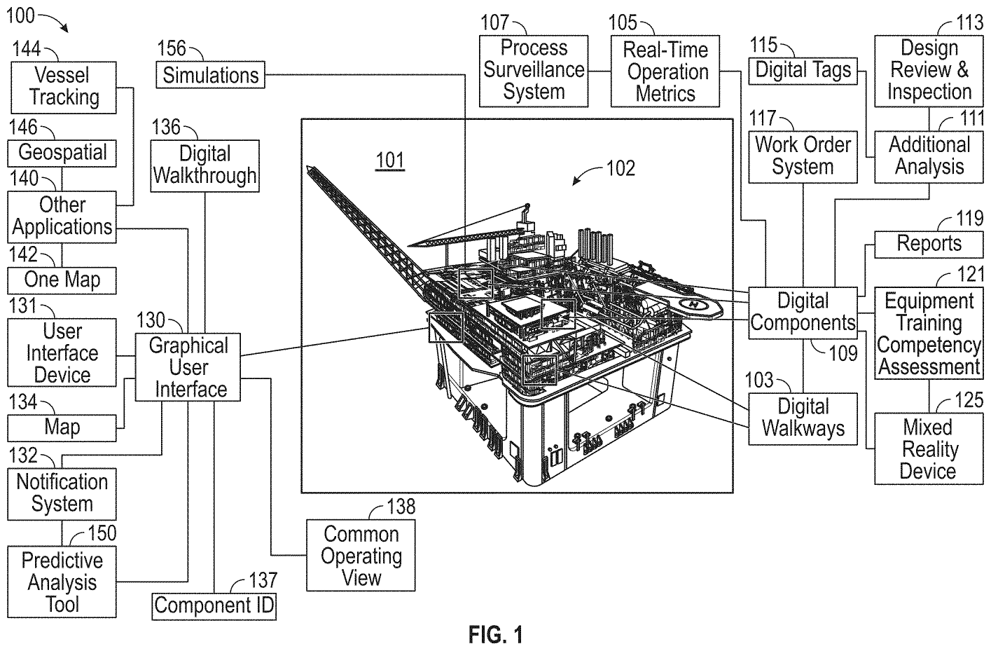

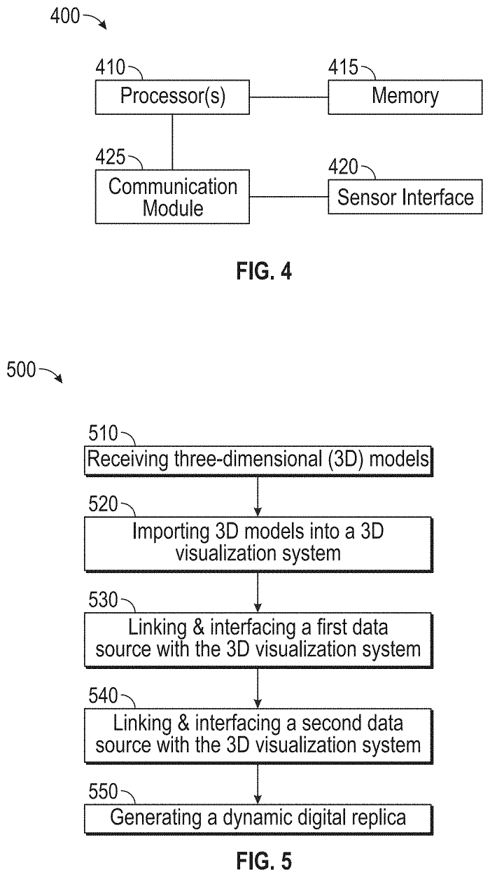

Refer now to FIG. 1, a computer system 100 for displaying a screen image 101 illustrating a portion of a dynamic digital replica 102 of an offshore production facility is shown. The computer system 100 may be the computer system discussed below with respect to FIG. 4, for example. The screen image 101 of FIG. 1 illustrates the portion of the offshore production facility positioned above the sea. The screen image 101 includes a platform of the offshore production facility built on concrete or steel legs anchored directly onto the seabed. The additional equipment that is present on the seabed, for example, trees, manifold, pipeline end termination system (PLET), riser, jumper, flowlines, etc., are not shown in FIG. 1. However, it should be appreciated that the description herein relates to dynamic digital replica of the complete offshore production facility, not just the portion of the dynamic digital replica 102 shown in the screen image 101.

The dynamic digital replica 102 is a computer-generated visualization of the complete offshore production facility such that the dynamic digital replica 102 acts as an information databank in all four dimensions of time and space. In particular, the dynamic digital replica 102 transforms currently implemented software systems that generate distributed dataset into a four-dimensional (three-dimensional (3D) space plus time) repository that can be visually and temporally browsed and analyzed. The time domain may be provided by the sensors placed on the production facility. For example, the sensors may be positioned on all the equipment used in the offshore production facility, where the sensors track the health of the equipment and provide dynamic tracking reports. These tracking reports may be accessed by the operator and may also be used to visually indicate the health of the equipment.

FIG. 1 also depicts various illustrative attributes of the dynamic digital replica 102, some of which enable the dynamic digital replica 102 to function as an interactive rendering of the offshore production facility. It should be appreciated that the attributes shown in FIG. 1 are not an exhaustive list. The attributes are shown to illustrate some of the capabilities of the dynamic digital replica 102. Given the wide variation of equipment, conditions, and situations that may be encountered in the offshore production facility, all possible attributes that may be needed for all the possible scenarios cannot possibly be presented in this specification. As such, only some examples of such scenarios will be provided in this specification.

Illustrative attributes of the dynamic digital replica 102 will now be described. One of the key attributes of the dynamic digital replica 102 is a graphical user interface (GUI) 130 that is accessible through a two-dimensional (2D) pixel matrix of display unit, for example, monitors of computers or display screens of other electronic devices, such as mobile phones, handheld computers, or computer-interfaced image projection devices, or a combination thereof. The GUI 130 interactively displays a four-dimensional (4D) view of the offshore production facility onto the 2D pixel matrix of display screens. The GUI 130 may be a component located on the production facility, for example. The GUI 130 provides the operator with a set of widgets, such as buttons, sliders, choice and list boxes, which enable the operator to generate requests, which may include transferring from one type of viewpoint to another. The GUI 130 may be accessible utilizing a web browser that provides the operator with access to the most recent version of the GUI 130, independent of the combination of hardware and operating system utilized and independent of the location of the hardware and operating system. For example, the dynamic digital replica 102 may be viewed at a location remote from the actual location of the offshore production facility, such as a regional service office or an operations headquarters.

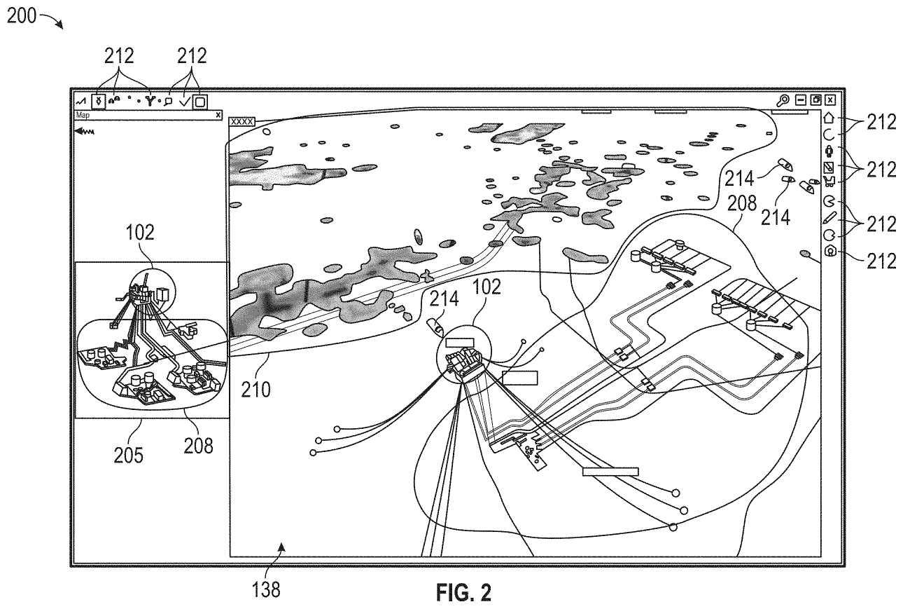

Referring briefly to FIG. 2, an illustrative GUI 200 is depicted. The GUI 200 may be the GUI 130 (FIG. 1), for example. The GUI 200 includes a dynamic digital replica of the complete offshore production facility, which includes the view of the dynamic digital replica 102 as shown in FIG. 1 and other components 208 that may form the offshore production facility. The components 208 are shown to be present on a sea bed. The GUI 200 also depicts a map 205 that shows the complete offshore production facility. The GUI 200 further depicts a set of widgets 212 that are present on the top and side of the GUI 200. In one example, the widgets 212 on the top of the GUI 200 may include a tree view option and a change view option, and the widgets 212 on the side of the GUI 200 may include a filter option, a dimension measurement option, an adding text option, a changing color option, etc.

Assume that the GUI 200, when turned on for the first time, displays a full-field digital replica view (as shown in FIG. 2) illustrating a common operating view 138 (FIG. 1), which includes a real-time weather view 210 and a view of locations of vessels 214 overlaid upon a view of all other components coupled to the offshore production facility and sharing similar map coordinates to the real-time weather view 210 and the view of the locations of vessels 214. The view of locations of vessels 214 may be generated utilizing an automatic identification system (AIS). The AIS shows real-time locations of the vessels using transponders on the ships via a vessel tracking 144 (FIG. 1). Now, the operator can select the appropriate widgets to access a desired dynamic digital replica, for example, the offshore production facility as shown in the view of the dynamic digital replica 102. After selecting the offshore production facility as represented by the view of the dynamic digital replica 102 in the GUI 200, the operator may see a view as shown in screen image 101 as shown in FIG. 1, for example.

Referring again to FIG. 1, as noted above, the dynamic digital replica 102 of the offshore production facility is interactive in that operators can manipulate the spatial location and orientation of the perspective viewpoint of the facility via a user interface device 131, such as a mouse, joystick, trackball, or touchscreen, to create an effect of actually walking through the computer-generated 4D visual scene. This walking through attribute is herein referred to as a digital walkthrough 136. During the digital walkthrough 136, the operator may perform a component ID 137 by selecting, highlighting, identifying, and accessing various digital equivalents of the equipment. This creates a first-person user experience of the facility even when being remote. To perform a digital walkthrough 136, for example, the operator may zoom in and select to view one of the digital walkways 103 on the facility. While on one of the digital walkways 103, the operator may digitally walk around the platform and, using the user interface device 131, select a piece of equipment in the instant visual scene. For example, the operator may select a digital equivalent of a piece of equipment, an iron roughneck present in the instant visual scene, of one of the digital walkways 103. In other examples, the operator may utilize the component ID 137 to view the component without first selecting one of the digital walkways 103.

As can be seen in FIG. 1, some of the attributes are depicted as being linked with other attributes. However, such links between attributes does not imply a relationship, such as dependence or causality. The links are merely shown to provide examples of the way in which one or more of the attributes can function together. There may be one or more of the attributes that may not be linked but that can function together. For example, an operator using the user interface 130 can perform the digital walkthrough 136 and can perform the component ID 137 during the digital walkthrough 136. In some examples, equipment can be identified by digital tags 115 that may mark each piece of equipment present in the digital walkthrough 136. In other examples, the operator may need to utilize the user interface device 131 to select the digital equivalent of the equipment to see the digital tags 115.

In addition to identifying components, the dynamic digital replica 102 is configured to provide more details on the identified component. For the sake of illustration, assume that the operator identifies a digital component 109 as a pump while digitally walking through one of the digital walkways 103 of the dynamic digital replica 102. The operator can access real-time operation metrics 105 of the identified digital component 109. For example, the operator can gather live equipment and process data such as vibration data, shaft speed, flow rate, pressure, and temperature, etc. of the pump. In addition to real-time operation metrics 105, the operator can also access reports 119 of the identified digital component 109. For example, the operator may access specification reports, schematics, reliability reports, maintenance history, integrity database, data sheet, pump curve, and equipment health assessment, etc. of the pump. After accessing these reports, the operator may review and inspect the design of the identified digital component 109 utilizing a design review and inspection 113.

In addition to being able to check real-time operation metrics 105, the dynamic digital replica 102 is configured to perform additional analysis 111 on the instant visual scene or any selected component or piece of equipment. For example, assume that the GUI 130 displays the offshore production platform shown in the screen image 101. The operator, using the appropriate widgets on the GUI, can view a corrosion circuit model of the complete offshore production platform. Corrosion circuit modeling is carried out as part of a risk-based analysis (RBA). Corrosion circuit modeling combines fluid type and piping materials or chemical make-up into systems or sub-systems, which can be grouped into corrosion or erosion mechanisms. These mechanisms are monitored over the operating lifetime of the facility in accordance with an operating management system (OMS) that defines a systematic and consistent approach for managing operating activities. The OMS may be implemented as an OMS application of other applications 140 available through the GUI 130. By utilizing the OMS, the dynamic digital replica 102 allows visualization and connection of disparate data to improve performance, reinforcing a commitment to operate safe and reliable operations compliant with the OMS. This monitoring is further utilized in the integrity management plan (IMP) which, in some examples, may form a part of the overall asset integrity management system. In addition to viewing the corrosion circuit of the offshore production platform, the operator may isolate a particular corrosion circuit and access risk-based analysis reports of the isolated corrosion circuit. Furthermore, the operator may also access piping and instrumentation diagram of the isolated corrosion circuit.

The additional analysis is not limited to corrosion circuits. In other examples, additional analysis 111 may also include comparing theoretical design calculations and actual operating conditions—for example comparing actual erosion data with erosion modeling data, actual turbine thermodynamic data with turbine thermodynamic modeling, etc. These comparisons are monitored over the operating lifetime of the facility in accordance with the OMS. In some examples, the dynamic digital replica may allow viewing of a predicted aging of a piece of equipment, of a system, or of the production facility as a whole. The predicted aging may be based on one of the plurality of models available. For example, the dynamic digital replica 102 may provide a view of corrosion within the production facility six months from a current date utilizing theoretical calculations, actual operating conditions, past data, or a model based on a combination thereof to predict and display the aging of the piece of equipment, the system, or of the production facility as a whole. This capability allows an operator to schedule maintenance as well as predict possible operations interruptions for further analysis.

The GUI 130 may allow access to a map 134 that provides the operator another spatial viewpoint on the operator's instant spatial location on or in the dynamic digital replica 102. For example, using the user interface device 131, the operator may digitally walk to a location in the dynamic digital replica 102 where a pump is placed. At this point, the operator may see on the display screen her current location within the dynamic digital replica 102. The current location in the map 134, in some examples, may be labeled or marked as a colored dot.

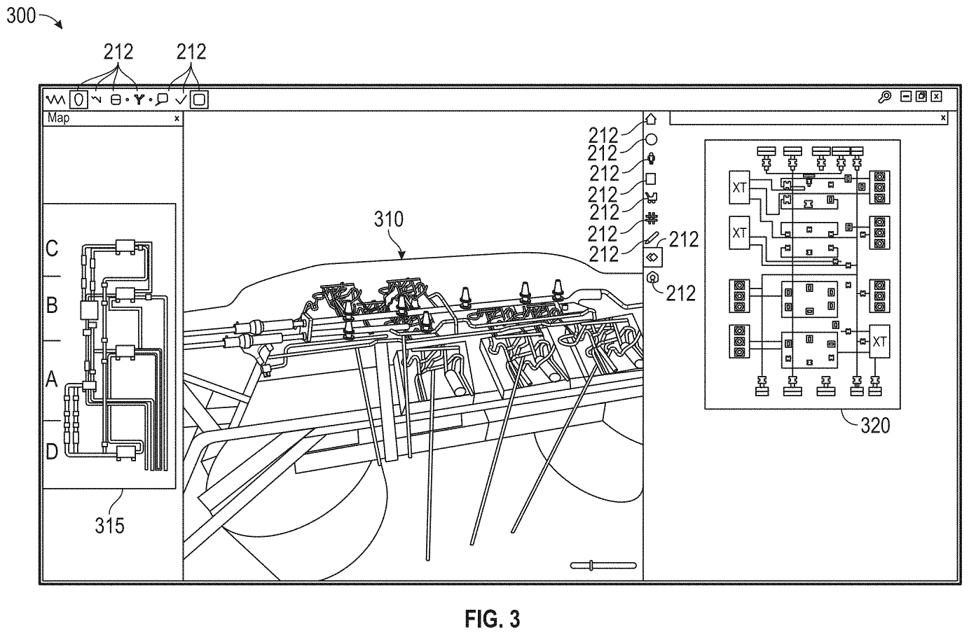

The dynamic digital replica 102 also includes a process surveillance system 107 that provides live process data for selected pieces of equipment or systems of the offshore production facility. Refer briefly to FIG. 3, an illustrative GUI 300 showing a view of equipment 310 placed on the seabed. The GUI 300 may be the GUI 130 (FIG. 1), for example. The equipment 310 may be a sub-system or system shown by selecting one or more than one of the components 208 of the common operating view 138 of the GUI 200, for example. The GUI 300 shows the widgets 212, an overall field view 315, a detail schematic diagram 320, and live process data of the equipment 310. The equipment 310 includes motors and pipes pumping oil in real-time from the reservoir underneath the seabed. The live process data includes flow direction, flow rate, pressure, and temperature. The live process data also allows for the operator to manipulate a sub-system or sub-component of the equipment 310 and analyze the effect it may have on the overall system. For example, the operator, using the user interface device, may turn-off a valve and check the effect of the action on the equipment 310. This capability is especially useful in examples where a portion of equipment needs to be replaced and the operator wants to check the effect the downtime will have on the other systems. In another example, the operator may utilize the turned-off valve as an input into the OMS application to determine the effect the downtime will have on the other systems.

The dynamic digital replica 102 also includes a predictive analysis tool 150 that predicts a reason for a decreased performance or failure of a component or a system, and analyzes a downtime to repair the faulty component or system, thereby improving reliability of the equipment and reducing overall downtime by assisting operators to diagnose and respond to issues in real-time. For example, the dynamic digital replica 102 can identify heat exchanger fouling and predict a pump that is not operating at its desired performance. The pump may be repaired or replaced prior to failure, thereby reducing further damage to the system and an increased downtime for repairs.

The following example describes one scenario where the predictive analysis tool facilities equipment maintenance and thus prevents downtime. Assume that the predictive analysis tool 150 predicts that a shutdown valve will stop meeting its required closure time in the near future. The predictive analysis tool 150, in some examples, may notify the relevant operations team using a notification system 132. The notification system 132 maybe an alert system that may be present in the GUI 130, for example. An operator from the relevant operations team then may investigate the notification and locate the shutdown valve in the dynamic digital replica 102 to perform further analysis. Further analysis may include reviewing the consequences if the shutdown valve is taken off the grid while it is replaced. In an example, the operator may utilize the OMS application to evaluate the consequences if the shutdown valve is taken off the grid while it is replaced. After performing the relevant analysis, the operator may draft an operational risk assessment report in a control of work system and provide a solution to the problem. In another example, the operator may utilize the OMS application to generate the draft of the operation risk assessment, for example. If the solution is not readily available, the operator may continue to troubleshoot the issue until the problem is rectified. In yet another example, the final solution to rectify the problem may be utilized as an input into the OMS application to improve the performance of the OMS application.

While troubleshooting the problem, the operator may utilize different attributes of the dynamic digital replica 102. For example, the operator may access a work order history of the valve from a work order system 117 to review all the preventative and corrective maintenance performed on the valve in the past year. In addition, the operator may also access the real-time operation metrics 105 of the equipment in which the valve is present. The operator can also view the pneumatic schematic in the reports 119. If, after troubleshooting, it is concluded that the valve needs to be replaced, the operator can access a spare parts inventory and confirm whether a warehouse has a replacement part.

In summary, the dynamic digital replica 102 facilitates maintenance activities by aggregating all relevant data in one visual repository (dynamic digital replica 102), where an operator can access the relevant data more efficiently and without creating redundancies.

In one example, dynamic digital replica 102 utilizes a digital tag algorithm that facilitates accessing relevant details based on the digital tags 115. The digital tags 115 may be used to identify pieces of the equipment and their associated activities or documents. The digital tag algorithm searches and cross-references all systems and data to generate relevant output based on the digital tags 115 of the identified equipment. This allows users to navigate around the plethora of information visually using the dynamic digital replica 102. Additionally, using the digital tag algorithm reveals discrepancies between data sources and allows rectification of the discrepancy at its source, which in turn improves quality and accuracy. By implementing the digital tag algorithm in compliance with the OMS, a systematic and consistent approach for managing data is provided.

In some examples, the user interface 130 may also provide access to other applications 140. The other applications 140 are machine-readable instructions that cause a processor to perform the actions specified or to cause the actions to be performed by another component of a computer system. The computer system may be the computer system 100, for example. The other applications 140 include OneMap 142, geospatial data management 146, and vessel tracking 144, for example. OneMap 142 is configured to provide region-wide visibility of vessels, facility, subsea structure, and reservoir development data. Integrating OneMap 142 with the dynamic digital replica 102 assists with the vessel tracking 144. Geospatial data management 146 provides details related to the offshore production facility, including coordinates of the equipment, vessels, production facility, etc., and assists with defining a coordinate-based view of the common operating view 138, for example.

In some examples, the dynamic digital replica 102 is configured to provide equipment training competency assessments to essential personnel. The dynamic digital replica 102, in some examples, may be configured to perform simulations 156. The simulations 156 may be material handling simulations, for instance. In one example, the simulations 156 may be accessed by selecting a digital walkway. In another example, the simulations 156 may be accessed by selecting a digital component or a digital system. In yet another example, the simulations 156 may be accessed utilizing the GUI 130. In some examples, the GUI 130 may be assumed by a mixed-reality device 125. The mixed-reality device 125 may also be a component of the production facility, for example. The GUI 130 may display on a display screen of the mixed-reality device 125. The functions an operator may perform using the GUI 130 applies to the mixed-reality device 125, but instead of using the user interface device 131, the operator may use a user interface device related to the mixed-reality headset. The user interface device related to the mixed-reality device 125 may be sensors for detecting hand movements, for example.

Referring now to FIG. 4, an illustrative block diagram of a computer system 400 configured to implement the attributes of the dynamic digital replica 102 is shown. The computer system 400 may be the computer system 100 (FIG. 1), for example. In some examples, the computer system 400 includes a processor 410, a memory 415, a communication module 425, and a sensor interface 420. The computer system 400 may be a desktop computer system or a handheld device, such as a smartphone. In some examples, the computer system 400 is a standalone device, but in other examples, the computer system 400 is coupled to other machines where the computer system 400 is networked with other machines. In a network deployment, the computer system 400 operates as a server machine or a client machine in a server-client environment, or as a peer machine in a peer-to-peer environment. In other words—in some examples, the computer system 400 includes or corresponds to a server computer, a client computer, a personal computer (PC), a tablet computer, a laptop computer, a netbook, a mobile device, or any machine capable of executing, sequentially or otherwise, machine-readable instructions stored in the memory 415. The machine-readable instructions specify actions to be taken by the processor 410.

In some examples, the processor 410 may further include one or more microprocessors or digital signal processors (DSPs). In some examples, in addition to the microprocessors or DSPs, or alternatively, the processor 410 may include one or more application specific integrated circuits (ASICs) or field programmable gate arrays (FPGA). The processor 410 is configured to generate 3D interactive visual scenes for display on a display screen using 3D-accelerator-based graphics cards or special purpose graphics machines such as Silicon Graphics® workstations. In some examples, the memory 415 may include random access memory (RAM), read-only-memory (ROM), removable disk memory, flash memory, or a combination of these types of memories. The memory 415 may, at least in part, be used as cache (or buffer) memory, and typically includes an operating system (OS), which may be one of current or future commercially available operating systems such as, but not limited to, LINUX®, Real-Time Operating System (RTOS), etc. The sensor interface 420 is configured to receive information from the sensors placed in the production facility. Based on the received information, the processor 410 is configured to reflect dynamic change to the digital replica, meaning that the processor 410 adapts the digital replica over a life cycle of the production facility, at least in part based on the sensor data.

In certain examples, the dynamic digital replica 102 and its attributes may be at least partially processor-implemented. The performance of certain of the operations may be distributed among the one or more processors, not only residing within a single machine, but deployed across a number of machines. The one or more processors may also operate to support performance of the relevant operations in distributed software computing model, such as a “cloud computer environment,” for example, as a “software service” (SaaS). In some examples, at least some of the operations may be performed by a group of computers (as examples of machines including processors), these operations being accessible via a network (e.g., intranet, internet) and via one or more appropriate interfaces (e.g., Application Program Interfaces (APIs), GUIs). Having SaaS capability allows engineers and other crew to access the dynamic digital replica 102 from any display-enabled device, including a computer system, a smart phone device, a computer tablet device, or a mixed-reality device, for example.

Now refer to FIG. 5, an illustrative method 500 that can be used to generate the digital dynamic replica 102. The method 500 may be performed by the computer system 400 (FIG. 4). Method 500 may begin with receiving 3D models (block 510). The 3D models may be models of various components of the production facility and supplied by vendors of the various components, for example. As is widely known, a production facility includes various components (or equipment) and they are generally supplied by different vendors. For example, one company may be commissioned by the facility owner to supply equipment, including subsea blowout preventers and control systems, choke and kill manifold systems, and deep-water production riser and tensioner systems; and another company may be commissioned to provide a different set of equipment, including mud pumps. Thus, in block 510, the 3D models of the components supplied by vendors are received. In one example, the 3D models may include 3D models of the production facility, generators, a chemical injection skid, a turbine, heaters, separators, manifolds, trees, jumpers, risers, and an umbilical termination assembly, etc.

In one example, after receiving the 3D models, the method 500 moves to block 520 that includes importing the 3D models into a 3D visualization system. The 3D visualization system may be formed using a computer graphics language, for example, OpenGL™ or other related computer graphics language, which can generate 3D interactive visual scenes using 3D-accelerated PC-based graphics cards or special purpose graphics machines. The dynamic digital replica is built on the 3D visualization system. The GUIs depicted in FIGS. 2 and 3 are enabled with 3D graphics languages such as Virtual Reality Modeling Language and Java3D™ that display platform-independent 3D images and scenes in any web browser- and internet-enabled device. As noted above, in block 520, the method 500 imports the 3D models into the 3D visualization system, where importing includes recognizing and decoding file formats of the 3D models received. For example, a file format of the 3D models and the 3D visualization system may be different. In order for them to be compatible with each other, their file formats should match. Thus, performing the step described in block 520 allows for various file formats received from the vendors to be compatible with the 3D visualization system.

Method 500, following the block 520, moves to block 530 that includes linking and interfacing a first data source with the 3D visualization system, where the first data source includes equipment tags (e.g., digital tags 115 of FIG. 1), drawings, data sheets, and manuals of the respective component. For example, linking the first data source defines the digital tag (or the link) so that the equipment as seen in the 3D visualization system can be identified with its digital tag. This digital tag can be used to access other equipment-related details, such as drawings, data sheets, and manuals, which are also linked with the digital tag in block 530. Method 500 then proceeds to block 540 that includes linking and interfacing the 3D visualization system with a second data source, where the second data source includes a work order system 117 (FIG. 1), another integration (e.g., OneMap 142 of FIG. 1), a common operating view 138 (FIG. 2), real-time operation metrics 105 (FIG. 1), etc. Both blocks 530 and 540 utilize one or more appropriate interfaces (e.g., Application Program Interfaces (APIs)) to view the linked information in the GUI. After interfacing the linked data sources, generating the dynamic digital replica (block 550) includes providing an aggregate of all the distributed data in one single visualization tool.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method comprising:
receiving, by a computer system, data from a plurality of equipment of a production facility;
displaying, on a display unit of the computer system, a dynamic digital replica of the production facility, wherein accessing a digital replica of one of the plurality of equipment via the dynamic digital replica displays data for the one of the plurality of equipment of the production facility;
analyzing the data for the one of the plurality of equipment; and
generating, based on the analysis, a report on a health of the one of the plurality of equipment.

2. The method of claim 1 comprising displaying, on the display unit of the computer system, a real-time weather view and a real-time view of locations of vessels overlaid upon the dynamic digital replica of the production facility.

3. The method of claim 1 comprising performing a digital walkthrough of the production facility by accessing the digital replica of one of the plurality of equipment via the dynamic digital replica.

4. The method of claim 3 comprising displaying, on the display unit, a dynamic digital replica of the digital walkthrough.

5. The method of claim 1 comprising analyzing the data for the one of the plurality of equipment by digitally manipulating the one of the plurality of equipment and analyzing the effect the manipulation has on the production facility.

6. The method of claim 5 comprising predicting, based on the analysis, a failure of the one of the plurality of equipment and generating a notification.

7. The method of claim 1 comprising predicting, based on the analysis, a failure of the one of the plurality of equipment and generating a notification.

8. A system comprising:
a display unit;
a storage device comprising machine-readable instructions; and
a processor coupled to the display unit and the storage device, wherein execution of the machine-readable instructions causes the processor to:
cause the display unit to display a dynamic digital replica of a production facility comprising a plurality of equipment;
receive data on the plurality of equipment from multiple data sources;
analyze the data; and
based on the analysis, notify when an issue with one of the plurality of equipment is detected.

9. The system of claim 8 wherein multiple data sources comprises sensors on the plurality of equipment.

10. The system of claim 8 wherein the plurality of equipment comprises digital tags.

11. The system of claim 10 wherein execution of the machine-readable instructions causes the processor to aggregate the data utilizing the digital tags.

12. The system of claim 11 wherein execution of the machine-readable instructions causes the processor to identify discrepancies in the data utilizing the digital tags.

13. A computer-readable medium storing executable code which, when executed by a processor, causes the processor to:
display, on a display unit coupled to the processor, a dynamic digital replica of a production facility comprising a plurality of equipment, wherein the dynamic digital replica is configured to integrate multiple data sources providing a plurality of details related to the equipment;
analyze the multiple data sources; and
based on the analysis, notify when an issue with one of the plurality of equipment is detected.

14. The computer-readable medium of claim 1, when executed by the processor, causes the processor to adapt the dynamic digital replica over a life cycle of the production facility.

15. The computer-readable medium of claim 1, wherein the dynamic digital replica is configured to display real-time operation metrics of the equipment.

16. The computer-readable medium of claim 1, wherein the dynamic digital replica is configured to isolate a component of one of the plurality of the equipment and access relevant information related to the component through one or more of the multiple data sources.

17. The computer-readable medium of claim 1, wherein the dynamic digital replica is configured to be viewed from a plurality of different perspectives.

18. The computer-readable medium of claim 1, wherein the dynamic digital replica is configured to provide live process data relating to the equipment.

19. The computer-readable medium of claim 1, wherein the dynamic digital replica is configured to be viewed using a mixed-reality headset.

20. The computer-readable medium of claim 1, wherein the dynamic digital replica is configured to be viewed as a life-like structure having a life cycle comprising views of the digital replica in the past, present, future, or some combination thereof.
